(19) United States
(12) Patent Application Publication
(10) Pub. No.: US 2006/0087255 A1
(43) Pub. Date: Apr. 27, 2006

(54) Bulb of electrodeless lighting system

(75) Inventors: Joon-Sik Choi, Seoul (KR); Yong-Seog Jeon, Gyeonggi-Do (KR); Byeong-Ju Park, Seoul (KR); Hyun-Jung Kim, Seoul (KR); Yun-Chul Jung, Gyeonggi-Do (KR); Ji-Young Lee, Gyeonggi-Do (KR); Seung-Yeup Hyun, Seoul (KR); Dae-Kyung Kim, Seoul (KR); Ri-Na Hwang, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/029,373

(22) Filed: Jan. 6, 2005

(30) Foreign Application Priority Data
Oct. 26, 2004 (KR) 85921/2004

(51) Int. Cl. H05B 41/24

(52) U.S. Cl. 315/248; 315/246

(57) ABSTRACT

Disclosed is a bulb of an electrodeless lighting system, comprising: a resonator communicated with a waveguide which guides microwave energy generated in a microwave generator, for allowing light to pass therethrough and resonating the microwave energy therein; and a bulb placed in the resonator, for emitting light by exciting a light emitting material therein depending on the microwave energy, wherein the light emitting material is composed of a sulfur and an additive combined with the sulfur for varying a correlated color temperature during emission, thereby capable of varying the correlated color temperature of the light emitted from the bulb up to 6000K˜2500K with a high efficiency.

### BACKGROUND OF THE INVENTION

1. Field of the Invention

The present invention relates to a bulb of an electrodeless lighting system, and particularly, to a bulb of an electrodeless lighting system in which high efficiency is maintained and a correlated color temperature can be freely varied.

2. Description of the Background Art

In general, an electrodeless lighting system is a device which supplies microwave energy to an electrodeless plasma bulb and thereby emits visible rays or ultraviolet rays. Lives of the lamps are prolonged in comparison with typical incandescent lamps or fluorescent lamps, and have superior characteristics in a lighting effect.

FIG. 1 is a longitudinal sectional view showing an example of a conventional electrodeless lighting system.

An electrodeless lighting system using a conventional microwave energy, as can be seen from FIG. 1, is comprised of: a case 1 forming a certain inner space; a microwave generator 2 mounted in the case 1, for generating the microwave energy; a high voltage generator 3 for boosting a common alternating current (AC) power source to a high voltage and supplying it to the microwave generator 2; a waveguide 4 for guiding the microwave energy generated in the microwave generator 2; a resonator 6 communicatingly-installed at an outlet port 4a of the waveguide 4; and a bulb 5 placed in the resonator 6, for generating light by making a sealed material plasmatic by the microwave energy transmitted through the waveguide 4.

A reflector 7 for intensively reflecting the light generated in the bulb 5 forward is installed at a front side of the case 1 where is a peripheral region of the resonator 6.

Also, a dielectric mirror 8 is installed in the outlet port 4a of the waveguide 4, by which the microwave energy transmitted through the waveguide 4 is passed and the light emitted from the bulb 5 is reflected forward.

The sealed material of the bulb 5 is composed of a sulfur as a main component and an argon gas, an initial light emitting material.

On the other hand, a cooling fan 10 for cooling the microwave generator 2 and the high voltage generator 3 is installed at a rear part of the case 1. An unexplained reference numeral 11 refers to a fan motor and 12 refers to a bulb motor for rotating the bulb 5.

An operation of the conventional electrodeless lighting system will be described as follows.

When a driving signal is inputted into the high voltage generator 3, the high voltage generator 3 boosts AC power source and thereafter supplies the boosted voltage to the microwave generator 2. The microwave generator 2 then oscillates to generate microwave energy having remarkably high frequency. The generated microwave energy is emitted into the resonator 6 by being guided through the waveguide 4. The microwave energy emitted into the resonator 6 is then resonated in the resonator 6. At this time, the sealed material composed of the sulfur and the argon gas sealed in the bulb 5 is excited and discharged. While this, light having its own spectrum is generated, which is reflected forward by a reflector 7 and a dielectric mirror 8 and thereby lights up a lighting space.

In the bulb of the conventional electrodeless lighting system, as aforementioned, the sulfur of a main component and the argon gas of an initial light emitting material are sealed therein. The bulb can obtain a light having a correlated color temperature CCT of 6000K, and the light of 6000K has been generally known as a light which feels cold.

However, in the electrodeless lighting system, if a light, which feels warm, having the correlated color temperature of less than 4000K is required according to an installed place thereof or fancies of customers, the light of less than 4000K can not be achieved with a high efficiency by a bulb, in which the sulfur and argon gas are sealed, of the conventional electrodeless lighting system.

### SUMMARY OF THE INVENTION

Therefore, an object of the present invention is to provide a bulb of an electrodeless lighting system capable of maintaining a high optical efficiency and also of varying a correlated color temperature.

To achieve these and other advantages and in accordance with the purpose of the present invention, as embodied and broadly described herein, there is provided a bulb of an electrodeless lighting system which comprises: a resonator communicated with a waveguide which guides microwave energy generated in a microwave generator, for allowing light to pass therethrough and resonating the microwave energy therein; and a bulb placed in the resonator, for emitting light by exciting a light emitting material therein depending on the microwave energy, wherein the light emitting material is composed of a sulfur and an additive combined with the sulfur for varying a correlated color temperature during emission.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 a sectional view showing a structure of an electrodeless lighting system of the conventional art;

FIG. 2 is a sectional view showing a bulb of an electrodeless lighting system in accordance with an embodiment of the present invention; and

FIG. 3 is a graph showing an optical characteristic variation according to a bulb sealed material content of the present invention.

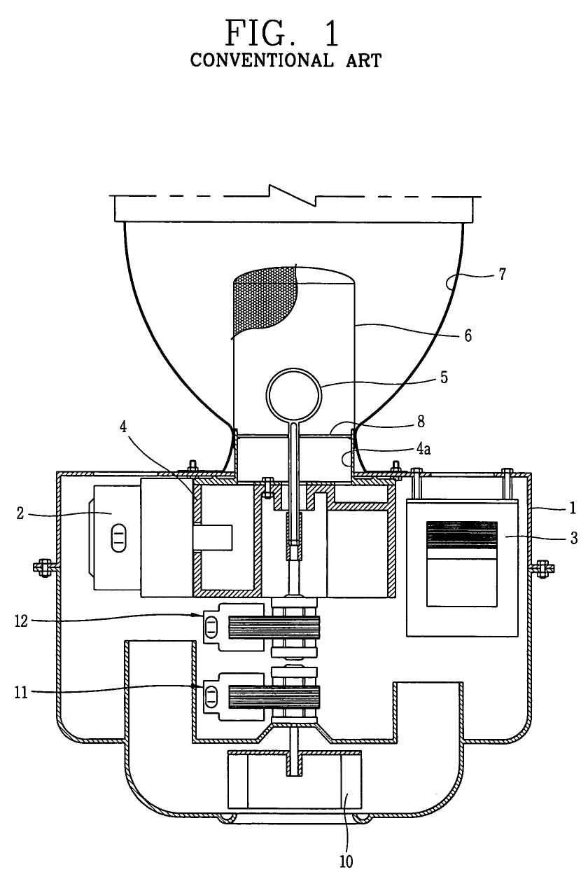

### DETAILED DESCRIPTION OF THE PREFERRED EMBODIMENTS

Reference will now be made in detail to the preferred embodiments of the present invention, examples of which are illustrated in the accompanying drawings.

An embodiment of a bulb of an electrodeless lighting system according to the present invention will be explained with reference to the attached drawings hereinafter.

There may exist various embodiments for a bulb of an electrodeless lighting system according to the present invention, and the most preferred embodiment therefor will be described hereinafter.

Here, a detailed explanation for a structure and an explanation same to the conventional electrodeless lighting system will be omitted.

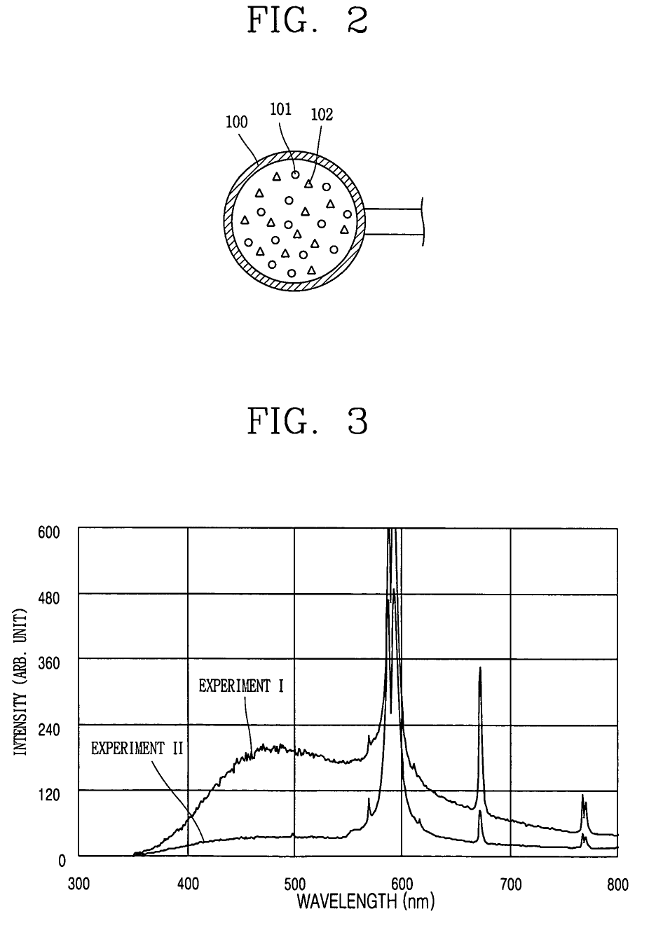

FIG. 2 is a sectional view showing a bulb of an electrodeless lighting system in accordance with an embodiment of the present invention, and FIG. 3 is a graph showing an optical characteristic variation according to a bulb sealed material content of the present invention.

As shown in those Figures, the bulb 100 of the electrodeless lighting system is formed in a spherical shape having a certain space therein. The bulb 100 contains therein sulfur 101, a main component of a light emitting material, and sodium iodide (Nal) 102 which is an additive capable of varying a correlated color temperature by being combined with the sulfur 101 during emission.

That is, since the light emitting material sealed in the bulb 100 is composed of the sulfur and the additive capable of varying the correlated color temperature CCT, the CCT can be varied up to 6000˜2500K with a high efficiency.

Na which is a metallic material in the sodium iodide (Nal) 102, the additive, generates a deep yellow spectrum having a wavelength of 589 nm thereby to be combined with a consecutive spectrum of the sulfur, and I therein performs a function of stabilizing the Na.

Referring to FIG. 3, when contents of the sealed material of the bulb, namely, the contents of the sulfur 101 and the sodium iodide 102 (the additive) are varied (See Experiments I and II), it can be noticed that an intensity of light in the experiments I and II is varied according to the wavelength. In other words, the optical characteristics can be varied according to a content variation of the bulb sealed material.

In both the experiments I and II, a bulb having a volume of 4.2 cc was used and the contents of the sealed materials, namely, the contents of the sulfur 101 and the sodium iodide 102 were varied, respectively.

In case of Experiment I, the sulfur 101 of 3.2 mg was added, and the sodium iodide 102 of 0.2 mg was added. At this time, seeing the optical characteristics, the correlated color temperature CCT was measured as 5843K, and a color rendering index CRI, which is a unit to estimate color rendering having a property of light source indicating a color reproducing fidelity of a lighted object, was measured as 75.

In case of Experiment II, the sulfur 101 of 1.5 mg was added, the sodium iodide 102 of 1.0 mg was added, the correlated color temperature CCT was measured as 2458K, and the color rendering index CRI was measured as 55.

As shown in the experiments in FIG. 3, since the additive, such as the sodium iodide 101, is added to the bulb 100, it can be noticed that an optical characteristic, particularly, the correlated color temperature CCT of the bulb 100 of the electrodeless lighting system can be varied.

The addition of the aforementioned sodium iodide is only an example. Here, the additive added to the bulb 100 for varying the correlated color temperature, namely, an optical characteristic, with a high efficiency is only formed of a metallic material.

The sodium Na is usually used as the metallic material. Also, a metallic material containing at least one or more of a scandium Sc and yttrium Y can be used. Additionally, one of lanthanide elements composed of La, Ce, Pr, Nd, Pm, Sm, Eu, Gd, Tb, Dy, Ho, Er, Tm, Yb, and Lu can be used as the metallic material.

Furthermore, halogenated compounds of a metal such as the sodium iodide can be used as the additive.

The halogenated compounds of the metal are preferably created by combining one of sodium Na, scandium Sc, Yttrium Y and La, Ce, Pr, Nd, Pm, Sm, Eu, Gd, Tb, Dy, Ho, Er, Tm, Yb, and Lu with one of halogen elements composed of F, Cl, Br, and I.

As stated above, the electrodeless lighting system allows the correlated color temperature of the emitted light to be easily varied from 6000K to 2500K with a high efficiency, by adding an additive capable of varying the correlated color temperature together with the sulfur, as a light emitting material sealed in the spherical bulb.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A bulb of an electrodeless lighting system, comprising:
a resonator communicated with a waveguide which guides microwave energy generated in a microwave generator, for allowing light to pass therethrough and resonating the microwave energy therein; and
a bulb placed in the resonator, for emitting light by exciting a light emitting material therein depending on the microwave energy,
wherein the light emitting material is composed of a sulfur and an additive mixed with the sulfur for varying a correlated color temperature during emission.

2. The bulb of claim 1, wherein the additive is a metallic material.

3. The bulb of claim 2, wherein the metallic material is sodium Na.

4. The bulb of claim 2, wherein the metallic material includes at least one or more of scandium Sc and yttrium Y.

5. The bulb of claim 2, wherein the metallic material includes one of lanthanide elements composed of La, Ce, Pr, Nd, Pm, Sm, Eu, Gd, Tb, Dy, Ho, Er, Tm, Yb, and Lu.

6. The bulb of claim 1, wherein the additive is a halogenated compounds of a metal.

7. The bulb of claim 6, wherein The halogenated compounds of the metal are created by combining one of sodium Na, scandium Sc, Yttrium Y and La, Ce, Pr, Nd, Pm, Sm, Eu, Gd, Tb, Dy, Ho, Er, Tm, Yb, and Lu with one of halogen elements composed of F, Cl, Br, and I.
